(19) United States
(12) Patent Application Publication
(10) Pub. No.: US 2006/0097491 A1
(43) Pub. Date: May 11, 2006

(54) Wrap-around inflatable curtain

(75) Inventors: Al A. Saberan, New Baltimore, MI (US); Charles E. Steffens JR., Washington, MI (US); Ali Emam Bakhsh, Rochester Hills, MI (US); Ayad G. Nayef, Sterling Heights, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 10/984,280

(22) Filed: Nov. 9, 2004

(51) Int. Cl. B60R 21/22

(52) U.S. Cl. 280/730.1; 280/730.2

(57) ABSTRACT

An apparatus (10) helps to protect an occupant (74) of a vehicle (12) that has a side structure (14) and an occupant compartment (70). The apparatus (10) includes an inflatable vehicle occupant protection device (100) that has a first portion (102) when inflated extending along the side structure (14) and a second portion (108) when inflated extending inboard from the side structure at or near a rear corner (112) of the occupant compartment (70).

### FIELD OF THE INVENTION

The present invention relates to an inflatable apparatus for helping to protect a vehicle occupant in the event of an impact to the vehicle, a vehicle rollover, or both.

### BACKGROUND OF THE INVENTION

It is known to inflate an inflatable vehicle occupant protection device to help protect a vehicle occupant. One particular type of inflatable vehicle occupant protection device is an inflatable curtain. The inflatable curtain is inflatable away from the roof of the vehicle between a vehicle occupant and the side structure of the vehicle in response to an impact to the vehicle, a vehicle rollover, or both. A known inflatable curtain is inflated from a deflated condition with inflation fluid directed from an inflator to the inflatable curtain.

### SUMMARY OF THE INVENTION

The present invention relates to an apparatus for helping to protect an occupant of a vehicle including a side structure and an occupant compartment. The apparatus includes an inflatable vehicle occupant protection device that has a first portion when inflated extending along the side structure and a second portion when inflated extending inboard from the side structure at or near a rear corner of the occupant compartment.

The present invention also relates to an apparatus for helping to protect an occupant of a vehicle that has a driver side including a side structure, a passenger side including a side structure, and a roof. The apparatus includes an inflatable vehicle occupant protection device that is inflatable away from the vehicle roof. The apparatus also includes an inflation fluid source for inflating the inflatable vehicle occupant protection device. The inflatable vehicle occupant protection device includes a first portion that is inflatable between the side structure on the driver side and rearwardmost seating of the vehicle. The inflatable vehicle occupant protection device also includes a second portion that is inflatable between the side structure on the passenger side and the rearwardmost seating of the vehicle. The inflatable vehicle occupant protection device further includes a third portion that is inflatable adjacent the rearwardmost seating and extending from the first portion to the second portion.

The present invention also relates to an apparatus for helping to protect an occupant of a vehicle that has a side structure and a roof. The apparatus includes an inflatable vehicle occupant protection device that is inflatable away from the vehicle roof. The inflatable vehicle occupant protection device includes a first portion that when inflated extends between the vehicle side structure and forwardmost and rearwardmost seating of the vehicle and a second portion that when inflated extends inboard from the first portion adjacent the rearwardmost seating.

The present invention also relates to an apparatus for helping to protect an occupant of a vehicle. The apparatus includes an inflatable curtain that has a first portion that, when inflated, extends along a side structure of the vehicle on a driver side of the vehicle. The apparatus also includes a second portion that, when inflated, extends along a side structure of the vehicle on a passenger side of the vehicle. The apparatus further includes a third portion that, when inflated, extends along a rear structure of the vehicle from the first portion to the second portion.

The present invention also relates to an apparatus for helping to protect an occupant of a vehicle. The apparatus includes an inflatable curtain that extends along a perimeter of a roof of the vehicle from near a forwardmost pillar of the vehicle to near a rearwardmost pillar of the vehicle. The inflatable curtain also extends along the perimeter of the roof from near the rearwardmost pillar of the vehicle to near a longitudinal centerline of the vehicle.

The present invention also relates to an apparatus for helping to protect occupants of a vehicle. The apparatus includes an inflatable vehicle occupant protection device. The protection device, when inflated, extends along the entire perimeter of a roof of the vehicle and downward into an occupant compartment of the vehicle so as to surround the occupant compartment to protect all occupants of the vehicle.

The present invention also relates to an apparatus for helping to protect occupants of a vehicle having an occupant compartment. The apparatus includes an inflatable vehicle occupant protection device that, when inflated, surrounds the occupant compartment to protect occupants in the occupant compartment.

The present invention also relates to an apparatus for helping to protect an occupant of a vehicle that has a side structure and a roof. The apparatus includes an inflatable vehicle occupant protection device that is inflatable away from the vehicle roof. A first portion of the protection device, when inflated, extends between the vehicle side structure and a seating position of the vehicle. A second portion of the protection device, when inflated, extends inboard from the first portion adjacent the seating position. The second portion terminates adjacent or just beyond a vehicle centerline.

The present invention further relates to an apparatus for helping to protect an occupant of a vehicle that has a driver side including a side structure, a passenger side including a side structure, and a roof. The apparatus includes a driver side inflatable vehicle occupant protection device that is inflatable away from the vehicle roof. The driver side protection device includes a first portion that when inflated extends between the driver side structure and a driver side seating position and a second portion that when inflated extends inboard from the first portion adjacent the driver side seating position. The apparatus also includes a passenger side inflatable vehicle occupant protection device that is inflatable away from the vehicle roof. The passenger side inflatable vehicle occupant protection device includes a third portion that when inflated extends between the passenger side structure and a passenger side seating position and a fourth portion that when inflated extends inboard from the third portion adjacent the passenger side seating position. The second and fourth portions having respective terminal end portions that abut each other adjacent a centerline of the vehicle.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a perspective view of an apparatus for helping to protect a vehicle occupant illustrating the apparatus in an inflated condition in a vehicle, according to a first embodiment of the present invention;

FIG. 2 is a schematic side view of the apparatus of FIG. 1 illustrating the apparatus in a deflated and stored condition in the vehicle;

FIG. 3 is a schematic side view of the apparatus of FIG. 2 in the inflated condition;

FIG. 4 is a schematic front view of the apparatus illustrating the apparatus in the deflated and stored condition;

FIG. 5 is a schematic front view of the apparatus in the inflated condition;

FIG. 6 is a schematic rear view of the apparatus illustrating the apparatus in the deflated and stored condition;

FIG. 7 is a schematic rear view of the apparatus in the inflated condition;

FIG. 8 is a perspective view of an apparatus for helping to protect a vehicle occupant illustrating the apparatus in an inflated condition in a vehicle, according to a second embodiment of the present invention;

FIG. 9 is a perspective view of an apparatus for helping to protect a vehicle occupant illustrating the apparatus in an inflated condition in a vehicle, according to a third embodiment of the present invention; and

FIG. 10 is a perspective view of an apparatus for helping to protect a vehicle occupant illustrating the apparatus in an inflated condition in a vehicle, according to a fourth embodiment of the present invention.

### DESCRIPTION OF EMBODIMENTS

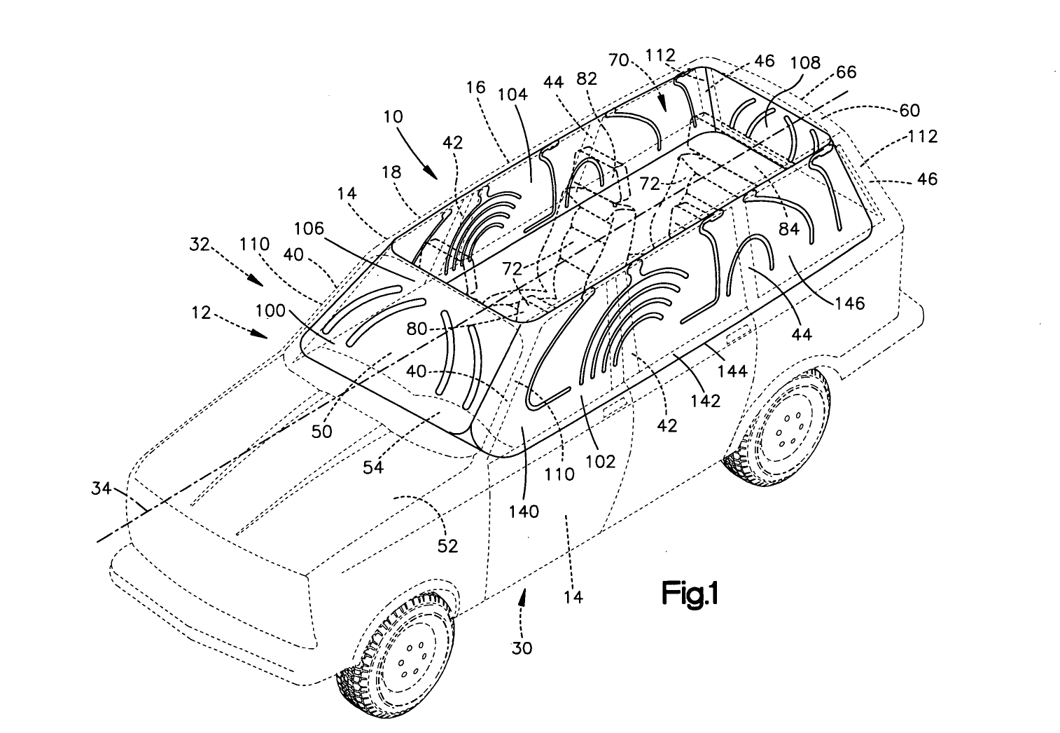

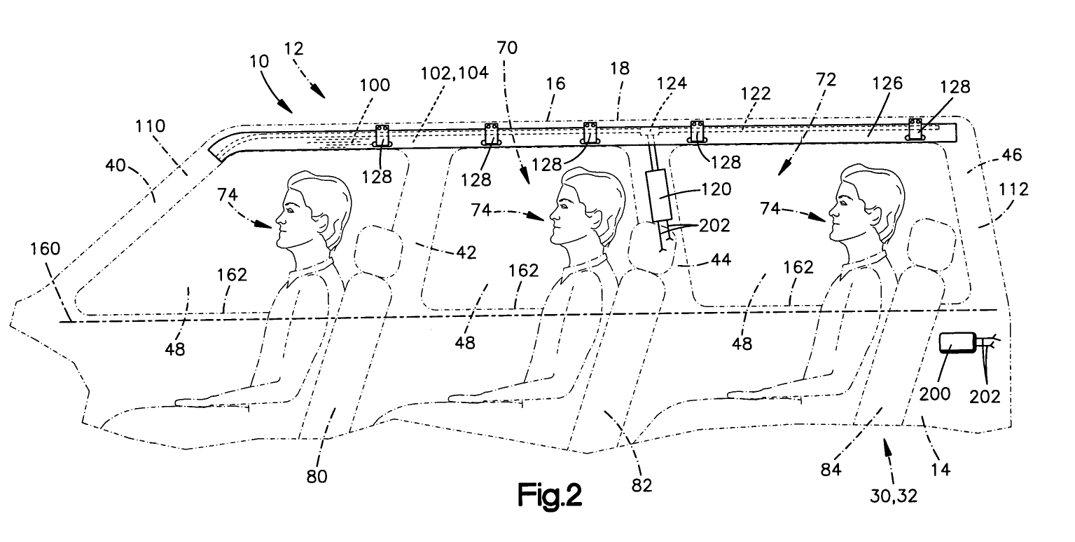

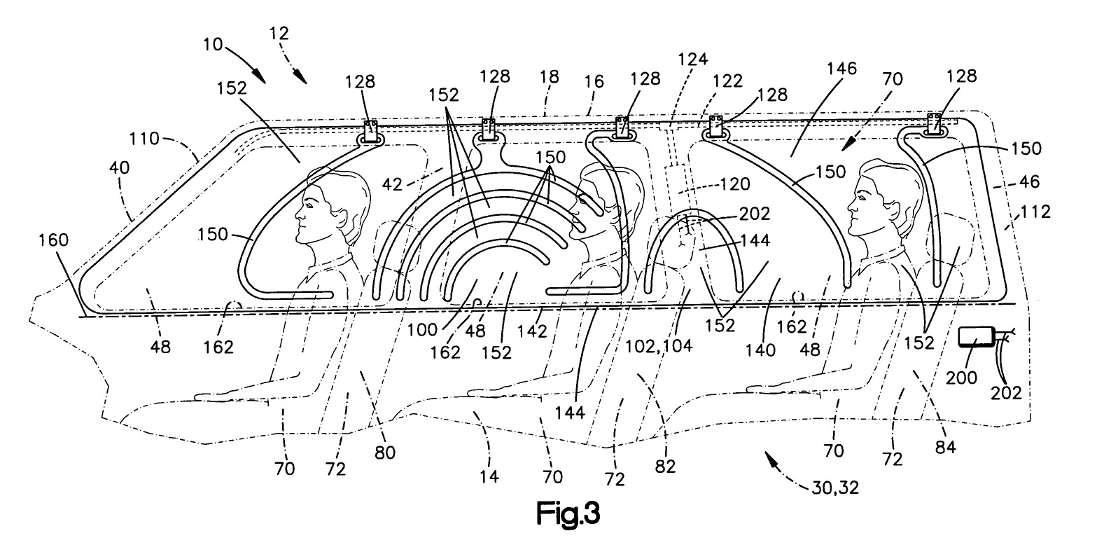

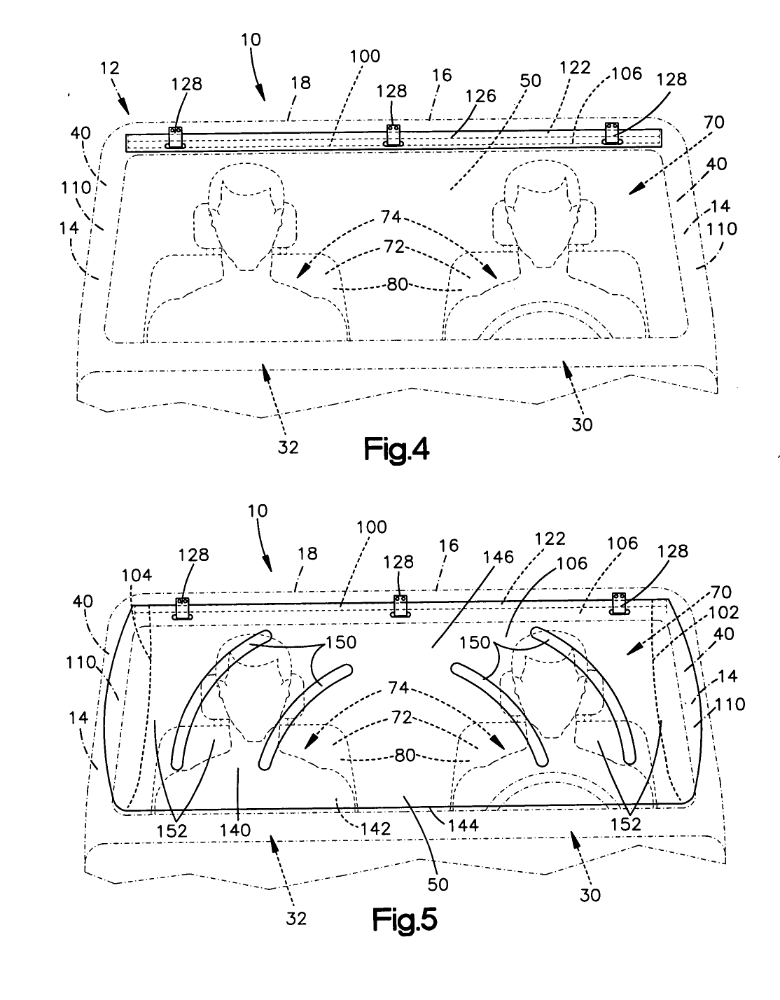

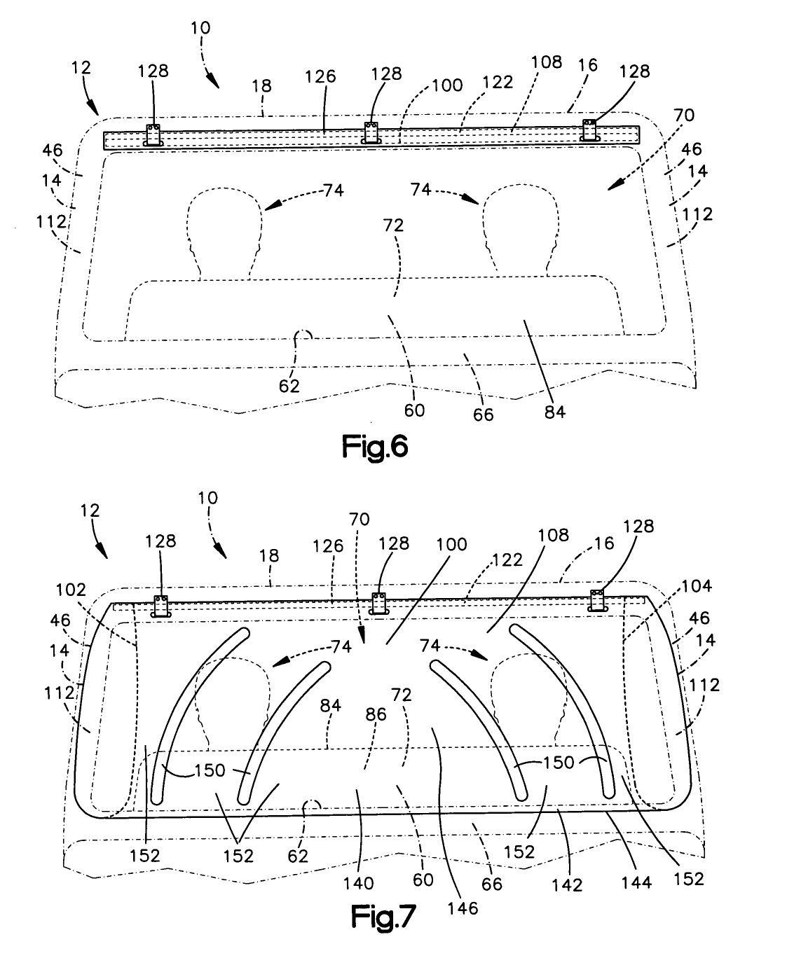

Representative of the present invention, an apparatus 10 helps to protect an occupant of a vehicle 12. The vehicle 12 has side structures 14 that extend along a driver side 30 and a passenger side 32 of the vehicle. The driver side 30 and passenger side 32 of the vehicle 12 may be defined on opposite sides of a longitudinal centerline 34 of the vehicle. FIGS. 2 and 3 are representative of the side structure 14 on both the driver side 30 and the passenger side 32 of the vehicle 12. In the embodiment illustrated in FIGS. 1-7, each side structure 14 includes an A pillar 40, B pillar 42, C pillar 44, and D pillar 46. The side structures 14 also include side window openings 48 between the pillars. The pillars 40, 42, 44, and 46 help support a roof 16 of the vehicle 12.

The vehicle 12 also includes a windshield opening 50 (FIGS. 1, 4, and 5) that has opposite lateral extents at or near the A pillars 40, an upper extent at or near the roof 16, and a lower extent at or near a hood 52 or instrument panel 54 of the vehicle 12. The vehicle 12 further includes a rear structure 66 that may comprise a rear door or tailgate of the vehicle 12. The rear structure 66 includes a rear window opening 60 that has opposite lateral extents at or near the D pillars 46, an upper extent at or near the roof 16, and a lower extent at or near a lower edge or sill 62 of the rear window opening.

The vehicle 12 also includes an occupant compartment 70 and vehicle seats 72 for supporting occupants 74 (FIGS. 2-7) in the occupant compartment. The vehicle 12 may include one or more rows of seating. In the embodiment illustrated in FIGS. 1-7, the vehicle 12 includes first row seating 80, second row seating 82, and third row seating 84. The first row seating 80 includes the forwardmost vehicle seats 72 on the driver side 30 and passenger side 32 of the vehicle 12. The third row seating 84 includes the rearwardmost vehicle seats 72 on the driver side 30 and passenger side 32 of the vehicle 12.

The apparatus 10 includes an inflatable vehicle occupant protection device in the form of an inflatable curtain 100 that is mounted adjacent the roof 16 of the vehicle 12. In the embodiment illustrated in FIGS. 1-7, the inflatable curtain 100 extends along an entire periphery 18 of the roof 16. The inflatable curtain 100 includes a driver side portion 102 that extends along the side structure 14 on the driver side 30 of the vehicle 12 from the A pillar 40 to the D pillar 46. The inflatable curtain 100 also includes a passenger side portion 104 that extends along the side structure 14 on the passenger side 32 of the vehicle 12 from the A pillar 40 to the D pillar 46.

The driver side portion 102 and the passenger side portion 104 may have similar configurations, each of which is represented in FIG. 3. In viewing FIG. 3 as representing the driver side 30 of the vehicle 12, the driver side portion 102 of the inflatable curtain 100 is viewed from outside the vehicle. In viewing FIG. 3 as representing the passenger side 32 of the vehicle 12, the passenger side portion 104 of the inflatable curtain 100 is viewed from inside the vehicle.

The inflatable curtain 100 also includes a windshield portion 106 that extends across the windshield opening 50 from the A pillar 40 on the driver side 30 to the A pillar on the passenger side 32. The inflatable curtain 100 further includes a rear portion 108 that extends across the rear structure 66 and the rear window opening 60 from the D pillar 46 on the driver side 30 to the D pillar on the passenger side 32.

The inflatable curtain 100 includes panels 140 of material that are arranged in an overlying manner. The panels 140 are interconnected along at least a portion of a perimeter 142 of the inflatable curtain 100 to form a perimeter connection 144 of the curtain. The perimeter connection 144 helps define an inflatable volume 146 of the inflatable curtain 100.

The inflatable curtain 100 may comprise a single inflatable volume 146 that extends along the driver side portion 102, passenger side portion 104, windshield portion 106, and rear portion 108. Alternatively, the inflatable volume 146 of the inflatable curtain 100 may comprise a plurality of separate inflatable volumes that are isolated from each other. For example, the driver side portion 102, passenger side portion 104, windshield portion 106, and rear portion 108 may comprise separate inflatable volumes that are isolated from each other. As another example, any of the portions 102, 104, 106, and 108 may themselves include a plurality of separate inflatable volumes that are isolated from each other.

The inflatable curtain 100 may also include interior connections 150 (see FIGS. 3, 5, and 7) in which the overlying panels 140 are interconnected within the perimeter 142 to form non-inflatable portions that help define inflatable chambers 152 of the curtain. The configuration of the interior connections 150, and thus the chambers 152, may vary depending on a variety of factors, such as the architecture of the vehicle 12, the position of the inflatable curtain 100 in the vehicle, and the desired extent or coverage of the curtain.

The inflatable curtain 100 may be formed in a variety of manners, such as by weaving the overlying panels 140 as a single piece of material, stitching the panels together, or interconnecting the panels via ultrasonic welding, heat bonding, or adhesives. In a one piece woven construction, the overlying panels 140 may be woven simultaneously from a material, such as nylon yarn, and may be coated with a gas impermeable material, such as urethane, or laminated with a gas impermeable film. The inflatable curtain 100 thus may have a substantially gas-tight construction. Those skilled in the art will appreciate that alternative materials, such as polyester yarn, and alternatives coatings, such as silicone, may also be used to construct the inflatable curtain 100. It will also be appreciated that a variety of lamination schemes may be used to construct the inflatable curtain 100.

The apparatus 10 includes an inflation fluid source in the form of an inflator 120 (FIGS. 2 and 3) that is connected in fluid communication with the inflatable curtain 100 through a fill tube 122 (FIGS. 2-7). The fill tube 122 may be constructed of any suitable material, such as metal, plastic, or fabric. The fill tube 122 extends along the length of the inflatable curtain 100, i.e., along the driver side portion 102, passenger side portion 104, windshield portion 106, and rear portion 108. As shown in FIGS. 2 and 3, the inflator 120 may be connected with the fill tube 122 via a fitting 124, such as a “T” fitting.

Due to the relatively large inflatable volume 146 of the inflatable curtain 100, the apparatus may include more than one inflator 120 for providing inflation fluid for inflating the curtain. For example, the apparatus 10 may include four inflators 120, each being associated with a respective one of the driver side portion 102, passenger side portion 104, windshield portion 106, and rear portion 108 of the inflatable curtain 100. In such a configuration, each of the four inflators 120 may be connected in fluid communication with the single fill tube 122 that extends along the length of all of the portions 102, 104, 106, and 108 of the inflatable curtain 100. Alternatively, each of the four inflators 120 may be connected in fluid communication with separate, individual fill tubes (not shown), each associated with a respective one of the portions 102, 104, 106, and 108 of the inflatable curtain 100. The inflators 120 may be staged or sequenced in any suitable manner.

The inflator 120 contains a stored quantity of pressurized inflation fluid (not shown) in the form of a gas to inflate the inflatable curtain 100. The inflator 120 alternatively could contain a combination of pressurized inflation fluid and ignitable material for heating the inflation fluid, or could be a pyrotechnic inflator that uses the combustion of gas-generating material to generate inflation fluid. As a further alternative, the inflator 120 could be of any suitable type or construction for supplying a medium for inflating the inflatable curtain 100.

The apparatus 10 may include a housing 126 (FIGS. 2, 4 and 6) that stores the inflatable curtain 100 in a stored and deflated condition. The fill tube 122, the deflated inflatable curtain 100, and the housing 126 have an elongated configuration and extend along the vehicle roof 16 and along the side structure 14 above the side window openings 48, along the roof above the windshield opening 50, and along the roof above the rear window opening 60. The fill tube 122, inflatable curtain 100 and housing 126 are connected to the vehicle 12 by known means 128, such as brackets. Alternatively, the fill tube 122, inflatable curtain 100, housing 126, and inflator 120 could be connected to a headliner (not shown) of the vehicle 12 and installed in the vehicle as a unit with the headliner.

The vehicle 12 includes a sensor 200 (shown schematically in FIGS. 2 and 3) for sensing the occurrence of an event for which inflation of the inflatable curtain 100 is desired, such as an impact to the vehicle 12, a vehicle rollover, or both. Upon sensing the occurrence of such an event, the sensor 200 provides an electrical signal over lead wires 202 to the inflator 120. The signal causes the inflator 120 to be actuated in a known manner. The inflator 120, when actuated, discharges inflation fluid under pressure into the fill tube 122, which directs the inflation fluid into the inflatable curtain 100.

The inflatable curtain 100 inflates under the pressure of the inflation fluid from the inflator 120. The inflatable curtain 100 inflates away from the roof 16 in a downward direction as shown in the drawings and in a downward direction with respect to the direction of forward travel of the vehicle 12 into the position illustrated in FIGS. 1, 3, 5, and 7.

Referring to FIGS. 1 and 3, when the inflatable curtain 100 is inflated, the driver side portion 102 and passenger side portion 104 extend along the side structure 14 of the vehicle 12 on the driver side 30 and passenger side 32, respectively. The driver side portion 102 and passenger side portion 104 are positioned between the side structure 14 and the first, second, and third row seating 80, 82, and 84, and between the side structure and any occupant 74 of the vehicle 12. The driver side portion 102, when inflated, extends from the forwardmost pillar (the A pillar 40) to the rearwardmost pillar (the D pillar 46) on the driver side 30 of the vehicle 12. The passenger side portion 104, when inflated, extends from the forwardmost pillar (the A pillar 40) to the rearwardmost pillar (the D pillar 46) on the passenger side 32 of the vehicle 12. The driver side portion 102 and passenger side portion 104, when inflated, cover portions of their respective side structures 14, including the A, B, C, and D pillars 40, 42, 44, and 46, respectively, and the side window openings 48.

Referring to FIGS. 1 and 5, when the inflatable curtain 100 is inflated, the windshield portion 106 extends from the driver side portion 102 to the passenger side portion 104. The windshield portion 106 thus extends across the windshield opening 50 from adjacent or near the forwardmost pillar (the A pillar 40) on the driver side 30 to adjacent or near the forwardmost pillar (the A pillar) on the passenger side 32. The windshield portion 106, when inflated, covers portions of the windshield opening 50 and may cover portions of the A pillars 40.

Referring to FIGS. 1 and 7, when the inflatable curtain 100 is inflated, the rear portion 108 extends from the driver side portion 102 to the passenger side portion 104. The rear portion 108 thus extends across the rear structure 66 and the rear window opening 60 from adjacent or near the rearwardmost pillar (the D pillar 46) on the driver side 30 to adjacent or near the rearwardmost pillar (the D pillar) on the passenger side 32. The rear portion 108, when inflated, covers portions of the rear window opening 60 and may cover portions of the D pillars 46. The rear portion 108, when inflated, extends rearward of a seatback 86 of the third row seating 84 and below an upper extent of the seatback.

The driver side portion 102 and passenger side portion 104, when inflated, extend from adjacent or near the roof 16 down to adjacent or near a belt line 160 of the vehicle 12 adjacent lower edges or sills 162 of the side window openings 48. The driver side portion 102 and passenger side portion 104 could alternatively extend to above the belt line 160 or below the belt line.

The windshield portion 106 (FIG. 5), when inflated, extends from adjacent or near the roof 14 down to adjacent or near the instrument panel 54 of the vehicle 12. The rear portion 108 (FIG. 7), when inflated, extends from adjacent or near the roof 16 down to adjacent or near the lower edge 62 of the rear window opening 60. In the embodiment illustrated in FIGS. 1-7, the rear portion 108 extends just below the lower edge 62 of the rear window opening 60.

The inflatable curtain 100, when inflated, helps to protect a vehicle occupant in the event of an impact to the vehicle 12, a vehicle rollover, or both. In the embodiment of FIGS. 1-7, the inflatable curtain 100 extends along the entire perimeter 18 of the vehicle roof 16, i.e., from the A pillar 40 to the D pillar 46 on the driver side 30 and passenger side 32, between the A pillars at the forward end of the occupant compartment 70, and between the D pillars at the rearward end of the occupant compartment. The inflatable curtain 100 is positioned between the rows of seating 80, 82, and 84 and the side structure 14, windshield opening 50 and rear window opening 60. The inflatable curtain 100 wraps or extends around front corners 110 of the occupant compartment 70. The front corners 110 may be defined at the intersections of the side structures 14 and the windshield openings 50. The inflatable curtain 100 also wraps or extends around rear corners 112 of the occupant compartment 70. The rear corners may be defined at the intersections of the side structures 14 and the rear structure 66.

The driver side portion 102 and passenger side portion 104 extend along their respective side structures 14 from adjacent the forwardmost seating in the vehicle, i.e., the first row seating 80, to adjacent the rearwardmost seating in the vehicle, i.e., the third row seating 84. The windshield portion 106 extends inboard from the driver side portion 102 and passenger side portion 104 adjacent or forward of the forwardmost vehicle seating 80. The rear portion 108 extends inboard from the driver side portion 102 and passenger side portion 104 adjacent or rearward of the rearwardmost vehicle seating 84. The inflatable curtain 100, when inflated, is thereby positioned between occupants in any of the first, second, and third rows of vehicle seating 80, 82, 84 and the side structures 14, windshield opening 50, and rear window opening 60 of the vehicle 12.

Those skilled in the art will appreciate that the extent and coverage of the inflatable curtain 100 in the vehicle 12 may vary. The extent and coverage of the inflatable curtain 100 may vary depending on a variety of factors, such as the type, model, or architecture of the vehicle 12, the position of the inflatable curtain 100 in the vehicle, and the desired extent or coverage of the inflatable curtain.

For example, in a vehicle with a single row of vehicle seating, such as a single cab pickup truck (not shown), the inflatable curtain would extend along the side structure on the driver and passenger sides from the A pillar to the B pillar, across the windshield opening between the A pillars, and across the rear window opening between the B pillars. As another example, in a vehicle with a two rows of vehicle seating, such as a crew cab pickup truck (not shown), the inflatable curtain would extend along the side structure on the driver and passenger sides from the A pillar to the C pillar, across the windshield opening between the A pillars, and across the rear window opening between the C pillars.

In these alternative vehicle configurations, the inflatable curtain could extend along the entire perimeter of the vehicle roof. The driver side portion and passenger side portion would extend along their respective side structures from adjacent the forwardmost seating in the vehicle to adjacent the rearwardmost seat in the vehicle. In the case of the single cab pickup truck, the single row of vehicle seating would be both the forwardmost and rearwardmost seating in the vehicle. The windshield portion would extend inboard from the driver side portion and passenger side portion adjacent or forward of the forwardmost vehicle seating. The rear portion would extend inboard from the driver side portion and passenger side portion adjacent or rearward of the rearwardmost vehicle seating. The inflatable curtain, when inflated, would thereby be positioned between any occupants of the vehicle seating and the side structures, windshield opening, and rear window opening in these alternative vehicle architectures.

The inflatable curtain 100, when inflated, helps to absorb the energy of impacts with the curtain and helps to distribute the impact energy over a large area of the curtain. Since the inflatable curtain 100 extends along the perimeter 18 of the roof 16 and wraps or extends around corners of the occupant compartment 70, the curtain can help protect occupants 74 in events such as a front impact, rear impact, a side impact, an offset impact, an angled impact, a vehicle rollover, or combinations thereof. Also, in such events, the inflatable curtain 100 can help prevent an occupant 74 or a portion of an occupant from exiting the vehicle 12 through the side window openings 48, windshield opening 50, and rear window opening 60.

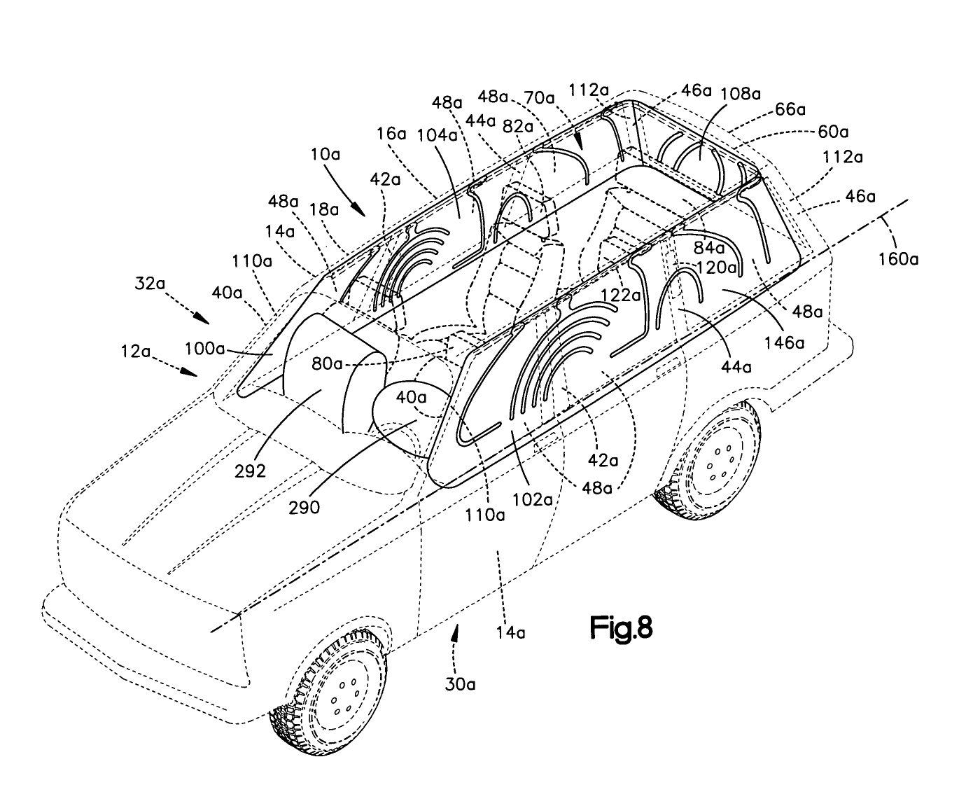

A second embodiment of the present invention is illustrated in FIG. 8. The second embodiment of the invention is similar to the first embodiment of the invention illustrated in FIGS. 1-7. Accordingly, numerals similar to those of FIGS. 1-7 will be utilized in FIG. 8 to identify similar components, the suffix letter “a” being associated with the numerals of FIG. 8 to avoid confusion.

The second embodiment of the present invention is similar to the first embodiment (FIGS. 1-7), except that the inflatable curtain of the apparatus of the second embodiment does not include a windshield portion. In this configuration, the vehicle 12a may include alternative means, such as a driver side air bag 290 and a passenger side air bag 292, inflatable between occupants of the vehicle and the windshield opening.

Referring to FIG. 8, the apparatus 10a includes an inflatable vehicle occupant protection device in the form of an inflatable curtain 100a that is mounted adjacent the roof 16a of the vehicle 12a. The inflatable curtain 100a includes a driver side portion 102a that extends along the side structure 14a on the driver side 30a of the vehicle 12a from the A pillar 40a to the D pillar 46a. The inflatable curtain 100a also includes a passenger side portion 104a that extends along the side structure 14a on the passenger side 32a of the vehicle 12a from the A pillar 40a to the D pillar 46a. The inflatable curtain 100a further includes a rear portion 108a that extends across the rear structure 66a and the rear window opening 60a from the D pillar 46a on the driver side 30a to the D pillar on the passenger side 32a.

The inflatable curtain 100a of the second embodiment has a material construction similar or identical to that of the inflatable curtain of the first embodiment (FIGS. 1-7), as described above. Also, the inflatable curtain 100a of the second embodiment may comprise a single inflatable volume 146a or a plurality of separate inflatable volumes that are isolated from each other. Further, the inflatable curtain 100a may include interior connections that form non-inflatable portions of the curtain, which help define inflatable chambers of the curtain. As shown in FIG. 8, the interior connections and inflatable chambers may have a configuration similar or identical to those illustrated in the first embodiment (FIGS. 1-7).

The apparatus 10a of the second embodiment includes an inflation fluid source in the form of an inflator 120a that is connected in fluid communication with the inflatable curtain 100a through a fill tube 122a. The inflator 120a and fill tube 122a of the second embodiment may have a material construction and configuration similar or identical to that of the first embodiment (FIGS. 1-7), as described above. Thus, the apparatus 10a may include a single inflator 120a or multiple inflators (not shown) and also may include a single fill tube or multiple fill tubes.

The apparatus 10a of the second embodiment may also include a housing (not shown) that has a configuration similar or identical to that of the first embodiment, as described above. The fill tube 122a, inflatable curtain 100a and housing may be connected to the vehicle 12a by known means (not shown), such as brackets, or could be connected to a headliner (not shown) of the vehicle 12a and installed in the vehicle as a unit with the headliner.

Upon sensing the occurrence of an event for which inflation of the inflatable curtain 100a is desired, such as a vehicle impact, a vehicle rollover, or both, a sensor (not shown) actuates the inflator 120a in a known manner. The inflator 120a, when actuated, discharges inflation fluid under pressure into the fill tube 122a, which directs the inflation fluid into the inflatable curtain 100a. The inflatable curtain 100a inflates under the pressure of the inflation fluid from the inflator 120a. The inflatable curtain 100a inflates away from the roof 16a in a downward direction as shown in the drawings and in a downward direction with respect to the direction of forward travel of the vehicle 12a into the position illustrated in FIG. 8.

When the inflatable curtain 100a is inflated, the driver side portion 102a and passenger side portion 104a extend along the side structure 14a of the vehicle 12a on the driver side 30a and passenger side 32a, respectively. The driver side portion 102a and passenger side portion 104a are positioned between the side structure 14a and the first, second, and third row seating 80a, 82a, and 84a, and between the side structure and any occupant (not shown) of the vehicle 12a. The driver side portion 102a, when inflated, extends along the side structure 14a and along the perimeter 18a of the roof 16a from the forwardmost pillar (the A pillar 40a) to the rearwardmost pillar (the D pillar 46a) on the driver side 30a of the vehicle 12a. The passenger side portion 104a, when inflated, extends along the side structure 14a and along the perimeter 18a of the roof 16a from the forwardmost pillar (the A pillar 40a) to the rearwardmost pillar (the D pillar 46a) on the passenger side 32a of the vehicle 12a. The driver side portion 102a and passenger side portion 104a, when inflated, cover portions of their respective side structures 14a, which may include portions of the A, B, C, and D pillars 40a, 42a, 44a, and 46a, respectively, and the side window openings 48a.

Referring to FIG. 8, when the inflatable curtain 100a is inflated, the rear portion 108a extends from the driver side portion 102a to the passenger side portion 104a. The rear portion 108a thus extends across the rear structure 66a, across the rear window opening 60a, and along the perimeter 18a of the vehicle roof 16a from adjacent or near the rearwardmost pillar (the D pillar 46a) on the driver side 30a to adjacent or near the rearwardmost pillar (the D pillar) on the passenger side 32a. The rear portion 108a, when inflated, covers portions of the rear window opening 60a and may cover portions of the D pillars 46a.

The driver side portion 102a and passenger side portion 104a, when inflated, extend from adjacent or near the roof 16a down to adjacent or near a belt line 160a of the vehicle 12a adjacent lower edges of the side window openings 48a. The driver side portion 102a and passenger side portion 104a could alternatively extend to above the belt line 160a or below the belt line. The rear portion 108a, when inflated, extends from adjacent or near the roof 16a down to adjacent or near a lower edge of the rear window opening 60a.

The inflatable curtain 100a, when inflated, helps to protect a vehicle occupant in the event of an impact to the vehicle 12a, a vehicle rollover, or both. The driver side portion 102a and passenger side portion 104a extend along their respective side structures 14a from adjacent the forwardmost seating in the vehicle, i.e., the first row seating 80a, to adjacent the rearwardmost seating in the vehicle, i.e., the third row seating 84a. The rear portion 108a extends inboard from the driver side portion 102a and passenger side portion 104a adjacent or rearward of the rearwardmost vehicle seating. The inflatable curtain 100a extends from front corners 110a of the occupant compartment 70a to the rear corners 112a of the occupant compartment and wraps or extends around the rear corners. The inflatable curtain 100a, when inflated, is thereby positioned between any occupants of the vehicle seating 80a, 82a, 84a and the side structures 14a, and between any occupants of the vehicle seating and the rear window opening 60a of the vehicle 12a.

Those skilled in the art will appreciate that the extent and coverage of the inflatable curtain 100a in the vehicle 12a may vary according to a variety of factors. For example, the extent and coverage of the inflatable curtain may depend on the type, model, or architecture of the vehicle 12a, the position of the inflatable curtain 100a in the vehicle, and the desired extent or coverage of the inflatable curtain.

For example, in a vehicle with a single row of vehicle seating, such as a single cab pickup truck (not shown), the inflatable curtain would extend along the side structure on the driver and passenger sides from the A pillar to the B pillar and across the rear window opening between the B pillars. As another example, in a vehicle with a two rows of vehicle seating, such as a crew cab pickup truck (not shown), the inflatable curtain would extend along the side structure on the driver and passenger sides from the A pillar to the C pillar and across the rear window opening between the C pillars. In both of these alternative vehicle configurations, the driver side portion and passenger side portion would still extend along their respective side structures from adjacent the forwardmost seating in the vehicle to adjacent the rearwardmost seat in the vehicle.

The inflatable curtain 100a, when inflated, helps to absorb the energy of impacts with the curtain and helps to distribute the impact energy over a large area of the curtain. Since the inflatable curtain 100a wraps or extends around rear corners 112 of the occupant compartment 70a, the curtain can help protect occupants in events such as a front impact, a rear impact, a side impact, an offset impact, an angled impact, or a vehicle rollover. Also, in such events, the inflatable curtain 100a can help prevent an occupant or a portion of an occupant from exiting the vehicle 12a through the side window openings 48a and rear window opening 60a.

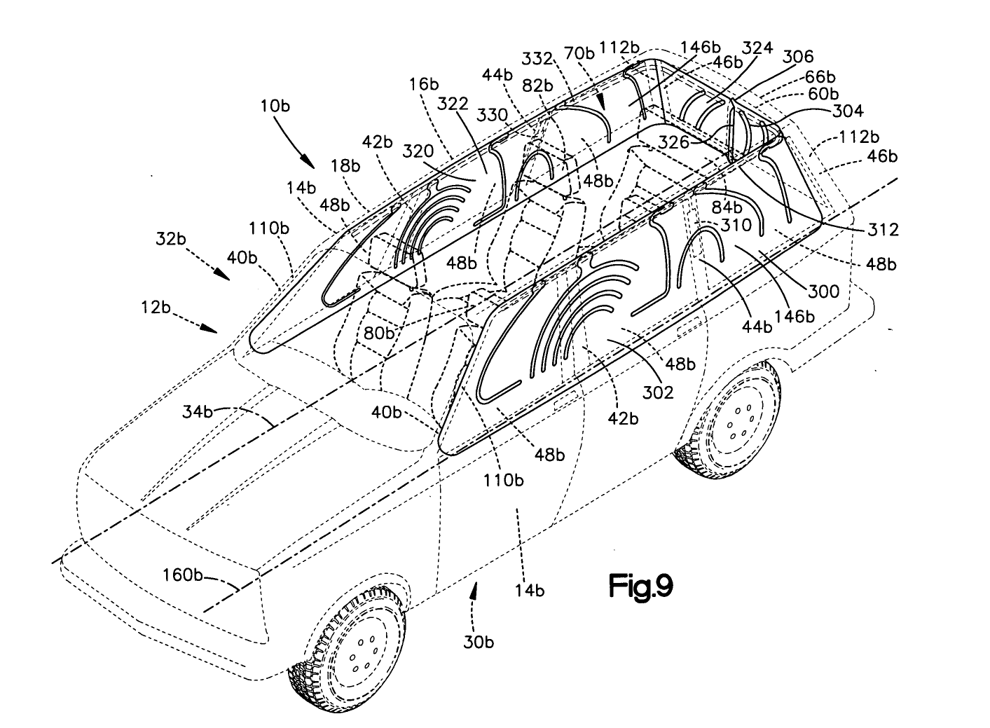

A third embodiment of the present invention is illustrated in FIG. 9. The third embodiment of the invention is similar to the first embodiment of the invention illustrated in FIGS. 1-7. Accordingly, numerals similar to those of FIGS. 1-7 will be utilized in FIG. 9 to identify similar components, the suffix letter “b” being associated with the numerals of FIG. 9 to avoid confusion.

Referring to FIG. 9, the apparatus 10b includes an inflatable vehicle occupant protection device in the form of an inflatable driver side curtain 300 and a separate inflatable passenger side curtain 320. The driver side curtain 300 and passenger side curtain 320 are mounted adjacent the roof 16b of the vehicle 12b. The driver side curtain 300 includes a side curtain portion 302 that extends along the side structure 14b on the driver side 30b of the vehicle 12b from the A pillar 40b to the D pillar 46b. The driver side curtain 300 also includes a rear portion 304 that extends inboard from the side curtain portion 302 to about or just beyond the centerline 34b of the vehicle 12b.

The passenger side curtain 320 includes a side curtain portion 322 that extends along the side structure 14b on the passenger side 32b of the vehicle 12b from the A pillar 40b to the D pillar 46b. The passenger side curtain 320 also includes a rear portion 324 that extends inboard from the side curtain portion 322 to about or just beyond the centerline 34b of the vehicle 12b. In the embodiment illustrated in FIG. 9, respective terminal end portions 306 and 326 of the rear portions 304 and 324 overlap each other. Alternatively, the rear portions 304 and 324 could terminate in abutting engagement with each other.

The driver side curtain 300 and passenger side curtain 320 of the third embodiment have material constructions similar or identical to that of the inflatable curtain of the first embodiment (FIGS. 1-7), as described above. Also, the driver side curtain 300 and passenger side curtain 320 of the third embodiment may comprise a single inflatable volume 146b or a plurality of separate inflatable volumes that are isolated from each other. Further, the driver side curtain 300 and passenger side curtain 320 may include interior connections that form non-inflatable portions of the curtain, which help define inflatable chambers of the curtain. As shown in FIG. 9, the interior connections and inflatable chambers may have a configuration similar or identical to those illustrated in the second embodiment (FIG. 8).

The apparatus 10b of the third embodiment includes an inflation fluid source in the form of inflators 310 and 330 that provide inflation fluid for inflating the driver side curtain 300 and passenger side curtain 320, respectively. The inflators 310 and 330 are connected in fluid communication with the inflatable curtain 100b through respective fill tubes 312 and 332. Alternatively, the driver side curtain 300 and passenger side curtain 320 each may include multiple inflators (not shown), multiple fill tubes (not shown), or both.

The apparatus 10b of the third embodiment may also include a housing or housings (not shown), associated with the driver side and passenger side curtains 300 and 320, that have configurations similar or identical to that of the first embodiment, as described above. The fill tubes 312 and 332, curtains 300 and 320, and housing may be connected to the vehicle 12b by known means (not shown), such as brackets, or could be connected to a headliner (not shown) of the vehicle and installed in the vehicle as a unit with the headliner.

Upon sensing the occurrence of an event for which inflation of the driver side curtain 300, passenger side curtain 320, or both is desired (e.g., a vehicle impact, a vehicle rollover, or both), a sensor (not shown) actuates the inflators 310 and 330 in a known manner. The inflators 310 and 330, when actuated, discharge inflation fluid under pressure into the fill tubes 312 and 332, which directs the inflation fluid into the curtains 300 and 320. The curtains 300 and 320 inflate under the pressure of the inflation fluid from the inflators 310 and 330, respectively. The curtains 300 and 320 inflate away from the roof 16b in a downward direction as shown in the drawings and in a downward direction with respect to the direction of forward travel of the vehicle 12b into the position illustrated in FIG. 9.

When the driver side curtain 300 and passenger side curtain 320 are inflated, the side curtain portions 302 and 322 extend along the side structures 14b of the vehicle 12b on the driver side 30b and passenger side 32b, respectively. The side curtain portions 302 and 322 are positioned between the side structure 14b and the first, second, and third row seating 80b, 82b, and 84b, and between the side structure and any occupant (not shown) of the vehicle 12b. The side curtain portion 302, when inflated, extends along the side structure 14b and along the perimeter 18b of the roof 16b from the forwardmost pillar (the A pillar 40b) to the rearwardmost pillar (the D pillar 46b) on the driver side 30b of the vehicle 12b. The side curtain portion 322, when inflated, extends along the side structure 14b and along the perimeter 18b of the roof 16b from the forwardmost pillar (the A pillar 40b) to the rearwardmost pillar (the D pillar 46b) on the passenger side 32b of the vehicle 12b. The side curtain portions 302 and 322, when inflated, cover portions of their respective side structures 14b, which may include portions of the A, B, C, and D pillars 40b, 42b, 44b, and 46b, respectively, and the side window openings 48b.

Referring to FIG. 9, when the driver side curtain 300 is inflated, the rear portion 304 extends from the side curtain portion 302 to just beyond the centerline 34b of the vehicle 12b. The rear portion 304 thus extends across the rear structure 66b, across the rear window opening 60b, and along the perimeter 18b of the roof 16b from adjacent or near the rearwardmost pillar (the D pillar 46b) on the driver side 30b to just beyond the centerline 34b of the vehicle 12b. The rear portion 304, when inflated, covers portions of the rear window opening 60b and may cover portions of the D pillar 46b on the driver side 30b.

When the passenger side curtain 320 is inflated, the rear portion 324 extends from the side curtain portion 322 to just beyond the centerline 34b of the vehicle 12b. The rear portion 324 thus extends across the rear structure 66b and the rear window opening 60b from adjacent or near the rearwardmost pillar (the D pillar 46b) on the passenger side 32b to just beyond the centerline 34b of the vehicle 12b. The rear portion 324, when inflated, covers portions of the rear window opening 60b and may cover portions of the D pillar 46b on the passenger side 32b.

The side curtain portions 302 and 322, when inflated, extend from adjacent or near the roof 16b down to adjacent or near a belt line 160b of the vehicle 12b adjacent lower edges of the side window openings 48b. The side curtain portions 302 and 322 could alternatively extend to above the belt line 160b or below the belt line. The rear portions 304 and 324, when inflated, extend from adjacent or near the roof 16b down to adjacent or near a lower edge of the rear window opening 60b. The rear portions 304 and 324 overlap each other near the centerline 34b and thus, in combination, cover the rear window opening 60b from the D pillar 46b on the driver side 30b to the D pillar 46b on the passenger side 32b.

The driver side curtain 300 and passenger side curtains 320, when inflated, help to protect a vehicle occupant in the event of an impact to the vehicle 12b, a vehicle rollover, or both. The side curtain portions 302 and 322 extend along their respective side structures 14b from adjacent the forwardmost seating in the vehicle, i.e., the first row seating 80b, to adjacent the rearwardmost seating in the vehicle, i.e., the third row seating 84b. The rear portions 304 and 324 extend inboard from the side curtain portions 302 and 322 adjacent or rearward of the rearwardmost vehicle seating 84b toward the centerline 34b.

The driver side curtain 300 extends from the front corner 110b of the occupant compartment 70b on the driver side 30b of the vehicle 12b to the rear corner 112b of the occupant compartment on the driver side and extends around the driver side rear corner toward the vehicle centerline 34b. The passenger side curtain 320 extends from the front corner 110b of the occupant compartment 70b on the passenger side 32b of the vehicle 12b to the rear corner 112b of the occupant compartment on the passenger side and extends around the passenger side rear corner toward the vehicle centerline 34b. The curtains 300 and 320, when inflated, are thereby positioned between any occupants of the vehicle seating 80b, 82b, 84b and the side structures 14b, and between any occupants of the vehicle seating and the rear window opening 60b of the vehicle 12b.

Those skilled in the art will appreciate that the extent and coverage of the driver side curtain 300 and passenger side curtain 320 in the vehicle 12b may vary according to a variety of factors. For example, the extent and coverage of the inflatable curtain may depend on the type, model, or architecture of the vehicle 12b, the position of the curtains 300 and 320 in the vehicle, and the desired extent or coverage of the inflatable curtains.

For example, in a vehicle with a single row of vehicle seating, such as a single cab pickup truck (not shown), the curtains would extend along the side structure on the driver and passenger sides from the A pillar to the B pillar and across the rear window opening between the B pillars. As another example, in a vehicle with two rows of vehicle seating, such as a crew cab pickup truck (not shown), the curtains would extend along the side structure on the driver and passenger sides from the A pillar to the C pillar and across the rear window opening between the C pillars. In both of these alternative vehicle configurations, the side curtain portions of the driver side curtain and passenger side curtain would still extend along their respective side structures from adjacent the forwardmost seating in the vehicle to adjacent the rearwardmost seat in the vehicle.

The driver side curtain 300 and passenger side curtain 320, when inflated, help to absorb the energy of impacts with the curtain and helps to distribute the impact energy over a large area of the curtain. Since the curtains 300 and 320 wrap or extend around corners of the occupant compartment 70b, i.e., corners at the intersections of the side structures 14b and the rear window structure 66b, the curtains can help protect occupants in events such as a front impact, a rear impact, a side impact, an offset impact, an angled impact, or a vehicle rollover. Also, in such events, the curtains 300 and 320 can help prevent an occupant or a portion of an occupant from exiting the vehicle 12b through the side window openings 48b and rear window opening 60b.

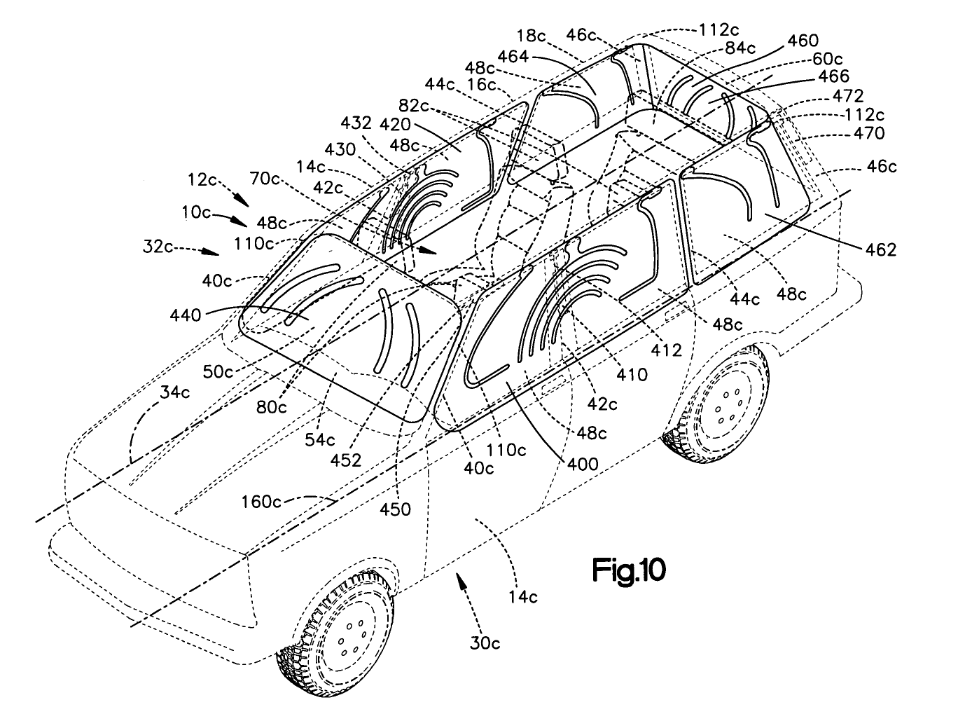

A fourth embodiment of the present invention is illustrated in FIG. 10. The fourth embodiment of the invention is similar to the first embodiment of the invention illustrated in FIGS. 1-7. Accordingly, numerals similar to those of FIGS. 1-7 will be utilized in FIG. 10 to identify similar components, the suffix letter “c” being associated with the numerals of FIG. 10 to avoid confusion.

Referring to FIG. 10, the apparatus 10c includes an inflatable vehicle occupant protection device in the form of an inflatable driver side curtain 400, an inflatable passenger side curtain 420, an inflatable windshield curtain 440, and an inflatable rear curtain 460. The curtains 400, 420, 440, and 460 are mounted adjacent the roof 16c of the vehicle 12c. The driver side curtain 400 extends along the side structure 14c on the driver side 30c of the vehicle 12c from the A pillar 40c to the C pillar 44c adjacent the first and second row seating. The passenger side curtain 420 extends along the side structure 14c on the passenger side 32c of the vehicle 12c from the A pillar 40c to the C pillar 44c adjacent the first and second row seating. The windshield curtain 440 extends from the A pillar 40c on the driver side 30c to the A pillar 40c on the passenger side 32c.

The rear curtain 460 includes a driver side portion 462 that extends along the side structure 14c on the driver side 30c of the vehicle 12c from the C pillar 44c to the D pillar 46c adjacent the third row seating. The rear curtain 460 also includes a passenger side portion 464 that extends along the side structure 14c on the passenger side 32c of the vehicle 12c from the C pillar 44c to the D pillar 46c adjacent the third row seating. The rear curtain 460 further includes a rear portion 466 that extends from the driver side portion 462 to the passenger side portion 464.

The driver side curtain 400, passenger side curtain 420, windshield curtain 440, and rear curtain 460 of the fourth embodiment have material constructions similar or identical to that of the inflatable curtain of the first embodiment (FIGS. 1-7), as described above. The curtains 400, 420, 440, and 460 are separate inflatable volumes that are isolated from each other. Each curtain 400, 420, 440, and 460 may include interior connections that form non-inflatable portions of the curtains, which help define inflatable chambers of the curtains. As shown in FIG. 10, the interior connections and inflatable chambers may have a configuration similar or identical to those illustrated in the first embodiment (FIGS. 1-7).

The apparatus 10c of the fourth embodiment includes an inflation fluid source in the form of inflators 410, 430, 450, and 470 that provide inflation fluid for inflating the driver side curtain 400, passenger side curtain 420, windshield curtain 440, and rear curtain 460, respectively. The inflators 410, 430, 450, and 470 are connected in fluid communication with their respective curtains 400, 420, 440, and 460 fill tubes 412, 432, 452, and 472. Alternative inflator configurations, such as multiple inflators for inflating a single curtain or a single inflator for inflating multiple curtains, may also be used.

The apparatus 10c of the fourth embodiment may also include a housing or housings (not shown), associated with the driver side curtain 400, passenger side curtain 420, windshield curtain 440, and rear curtain 460, that have configurations similar or identical to that of the first embodiment, as described above. The fill tubes 412, 432, 452, and 472, curtains 400, 420, 440, and 460, and housing may be connected to the vehicle 12c by known means (not shown), such as brackets, or could be connected to a headliner (not shown) of the vehicle and installed in the vehicle as a unit with the headliner.

Upon sensing the occurrence of an event for which inflation of the driver side curtain 400, passenger side curtain 420, windshield curtain 440, rear curtain 460, or a combination thereof is desired (e.g., a vehicle impact, a vehicle rollover, or both), a sensor (not shown) actuates the inflators 410, 430, 450, and 470 in a known manner. For example, the rear curtain 460 may be inflated upon sensing the occurrence of a rear impact to the vehicle 12c. As another example, the rear curtain 460 may be inflated to a reduced pressure in a scenario where the rear curtain is deployed for containment.

The inflators 410, 430, 450, and 470, when actuated, discharge inflation fluid under pressure into the fill tubes 412, 432, 452, and 472, which directs the inflation fluid into the curtains 400, 420, 440, and 460. The curtains 400, 420, 440, and 460 inflate under the pressure of the inflation fluid from the inflators 410, 430, 450, and 470, respectively. The curtains 400, 420, 440, and 460 inflate away from the roof 16c in a downward direction as shown in the drawings and in a downward direction with respect to the direction of forward travel of the vehicle 12c into the position illustrated in FIG. 10.

The driver side curtain 400 and passenger side curtain 420, when inflated, extend along the side structures 14c of the vehicle 12c on the driver side 30c and passenger side 32c, respectively. The driver side curtain 400 and passenger side curtain 420 are positioned between the side structure 14c and the first and second row seating 80c and 82c and between the side structure and any occupant (not shown) of the vehicle 12c. The driver side curtain 400, when inflated, extends along the side structure 14c and along the perimeter 18c of the roof 16c from the A pillar 40c to the C pillar 44c on the driver side 30c of the vehicle 12c. The passenger side curtain 420, when inflated, extends along the side structure 14c and along the perimeter 18c of the roof 16c from the A pillar 40c to the C pillar 44c on the passenger side 32c of the vehicle 12c. The driver side curtain 400 and passenger side curtain 420, when inflated, cover portions of their respective side structures 14c, which may include portions of the A, C, and C pillars 40c, 42c, and 44c, respectively, and the side window openings 48c.

The windshield curtain 440, when inflated, extends across the windshield opening 50c and is positioned between the windshield opening and any occupant (not shown) of the vehicle 12c. The windshield curtain 440 extends from the A pillar 40c on the driver side 30c to the A pillar 40c on the passenger side 32c and may cover the windshield opening 50c and portions of the A pillars 40c.

When rear curtain 460 is inflated, the driver side portion 462 and passenger side portion 464 extend along the side structures 14c of the vehicle 12c on the driver side 30c and passenger side 32c, respectively. The driver side portion 462 and passenger side portion 464 are positioned between the side structure 14c and the third row seating 84c and between the side structure and any occupant (not shown) of the vehicle 12c. The driver side portion 462, when inflated, extends along the side structure 14c and along the perimeter 18c of the roof 16c from the C pillar 44c to the D pillar 46c on the driver side 30c of the vehicle 12c. The passenger side portion 464, when inflated, extends along the side structure 14c and along the perimeter 18c of the roof 16c from the C pillar 44c to the D pillar 46c on the passenger side 32c of the vehicle 12c. The driver side portion 462 and passenger side portion 464, when inflated, cover portions of their respective side structures 14c, which may include portions of the C pillar 44c, D pillar 46c, and the side window openings 48c.

The driver side curtain 400, passenger side curtain 420, and side curtain portions 462 and 464 of the rear curtain 460, when inflated, extend from adjacent or near the roof 16c down to adjacent or near a belt line 160c of the vehicle 12c adjacent lower edges of the side window openings 48c. The driver side curtain 400, passenger side curtain 420, and side curtain portions 462 and 464 of the rear curtain 460 could alternatively extend to above the belt line 160c or below the belt line. The windshield curtain 440, when inflated, extends from adjacent or near the roof 16c down to adjacent or near the instrument panel 54c. The rear portion 466 of the rear curtain 460, when inflated, extends from adjacent or near the roof 16c down to adjacent or near a lower edge of the rear window opening 60c.

The driver side curtain 400, passenger side curtain 420, windshield curtain 440, and rear curtain 460, when inflated, help to protect a vehicle occupant in the event of an impact to the vehicle 12c, a vehicle rollover, or both. The driver side curtain 400, passenger side curtain 420, and rear curtain 440, in combination, extend along their respective side structures 14c from adjacent the forwardmost seating in the vehicle, i.e., the first row seating 80c, to adjacent the rearwardmost seating in the vehicle, i.e., the third row seating 84c. The rear portion 466 of the rear curtain 460 extends inboard from the side curtain portions 462 and 464 adjacent or rearward of the rearwardmost vehicle seating 84c toward the vehicle centerline 34c. The windshield curtain 440 inboard from the driver side curtain 400 and passenger side curtain 440 adjacent or forward of the forwardmost vehicle seating 80c toward the vehicle centerline 34c.

The driver side curtain 400, passenger side curtain 420, and rear curtain 460, in combination, extend from the front corner 110c of the occupant compartment 70c on the driver side 30c of the vehicle 12c to the rear corner 112c of the occupant compartment on the driver side, from driver side rear corner to the rear corner 112c of the occupant compartment on the passenger side 32c, and from the passenger side rear corner to the front corner 110c of the occupant compartment 70c on the passenger side 32c. The windshield curtain 440 extends from the front corner 110c of the occupant compartment 70c on the driver side 30c to the front corner 110c of the occupant compartment on the passenger side 32c. The curtains 400, 420, 440, and 460, when inflated, are thereby positioned between any occupants of the vehicle seating 80c, 82c, 84c and the side structures 14c, and between any occupants of the vehicle seating and the rear window opening 60c of the vehicle 12c.

Those skilled in the art will appreciate that the extent and coverage of the driver side curtain 400, passenger side curtain 420, windshield curtain 440, and rear curtain 460 in the vehicle 12c may vary according to a variety of factors. For example, the extent and coverage of the curtains 400, 420, 440, and 460 may depend on the type, model, or architecture of the vehicle 12c, the position of the curtains in the vehicle, and the desired extent or coverage of the curtains.

For example, in a vehicle with a single row of vehicle seating, such as a single cab pickup truck (not shown), the side curtains may be omitted, in which case the single rear curtain would extend along the side structure on the driver and passenger sides from the A pillar to the B pillar and across the rear window opening between the B pillars. As another example, in a vehicle with two rows of vehicle seating, such as a crew cab pickup truck (not shown), the side curtains would extend along the side structure on the driver and passenger sides from the A pillar to the B pillar, and the rear curtain would extend along the side structure from the B pillar to the C pillar and across the rear window opening between the C pillars. In both of these alternative vehicle configurations, curtain coverage is provided along both side structures from adjacent the forwardmost seating in the vehicle to adjacent the rearwardmost seat in the vehicle.

The driver side curtain 400, passenger side curtain 420, windshield curtain 440, and rear curtain 460, when inflated, help to absorb the energy of impacts with the curtains and helps to distribute the impact energy over large areas of the curtains. Since the curtains 400, 420, 440, and 460 wrap or extend around corners of the occupant compartment 70c, the curtains can help protect occupants in events such as a front impact, a rear impact, a side impact, an offset impact, an angled impact, or a vehicle rollover. Also, in such events, the curtains 400, 420, 440, and 460 can help prevent an occupant or a portion of an occupant from exiting the vehicle 12c through the windshield opening 50c, side window openings 48c, and rear window opening 60c.

From the above description of the invention, those skilled in the art will perceive improvements, changes and modifications. For example, in the embodiment of FIG. 1, the windshield portion may have a split configuration similar to that covering the rear window opening in the embodiment of FIG. 9. In this configuration, the driver side portion and passenger side portion would be connected with respective windshield portions that extend inboard to about or just beyond the vehicle centerline. In this configuration, the terminal end portions would abut each other or overlap each other. Other such improvements, changes and modifications within the skill of the art are intended to be covered by the appended claims.

Having described the invention, the following is claimed:

1. An apparatus for helping to protect an occupant of a vehicle including a side structure and an occupant compartment, said apparatus comprising an inflatable vehicle occupant protection device that has a first portion when inflated extending along the side structure and a second portion when inflated extending inboard from the side structure at or near a rear corner of the occupant compartment.

2. The apparatus recited in claim 1, wherein said second portion of said inflatable vehicle occupant protection device extends along a rear structure of the vehicle.

3. The apparatus recited in claim 2, wherein the side structure includes a rearwardmost pillar of the vehicle, the rear structure of the vehicle extending inboard of the side structure from near the rearwardmost pillar of the vehicle.

4. The apparatus recited in claim 2, wherein the rear structure includes a rear window opening, said second portion of said inflatable vehicle occupant protection device when inflated covering at least a portion of said rear window opening.

5. The apparatus recited in claim 1, wherein said second portion when inflated extends inboard from the side structure adjacent a seat back of rearwardmost seating in the vehicle.

6. The apparatus recited in claim 1, wherein said first and second portions of said inflatable vehicle occupant protection device comprise a single inflatable volume of said inflatable vehicle occupant protection device.

7. The apparatus recited in claim 1, wherein said first and second portions of said inflatable vehicle occupant protection device comprise separate inflatable volumes of said inflatable vehicle occupant protection device.

8. The apparatus recited in claim 1, further comprising a single inflator for inflating said inflatable vehicle occupant protection device.

9. The apparatus recited in claim 1, further comprising a plurality of inflators for inflating said inflatable vehicle occupant protection device.

10. The apparatus recited in claim 9, wherein said plurality of inflators comprises a first inflator for inflating said first portion and a second inflator for inflating said second portion.

11. The apparatus recited in claim 10, wherein said first and second inflators are adapted for sequential inflation of said inflatable vehicle occupant protection device.

12. The apparatus recited in claim 1, further comprising a third portion that when inflated extends inboard from said first portion between forwardmost seating of the vehicle and a windshield opening of the vehicle.

13. The apparatus recited in claim 1, wherein said first portion when inflated extends along the side structure from adjacent forwardmost seating of the vehicle to adjacent rearwardmost seating of the vehicle.

14. The apparatus recited in claim 1, wherein said first portion when inflated extends along the side structure from near a forwardmost vehicle pillar to near a rearwardmost vehicle pillar.

15. The apparatus recited in claim 14, wherein said second portion when inflated extends inboard from near the rearwardmost vehicle pillar.

16. The apparatus recited in claim 1, wherein said first portion when inflated extends along a perimeter of the vehicle roof from near a forwardmost vehicle pillar to near a rearwardmost vehicle pillar, and said second portion when inflated extends along a perimeter of the vehicle roof from near the rearwardmost vehicle pillar to near a longitudinal centerline of the vehicle.

17. The apparatus recited in claim 1, wherein said inflatable vehicle occupant protection device comprises a single inflatable volume.

18. The apparatus recited in claim 1, wherein said inflatable vehicle occupant protection device is inflatable in response to a rear impact with the vehicle.

19. An apparatus for helping to protect an occupant of a vehicle that has a driver side including a side structure, a passenger side including a side structure, and a roof, said apparatus comprising:
an inflatable vehicle occupant protection device that is inflatable away from the vehicle roof; and
said inflatable vehicle occupant protection device comprising a first portion inflatable between the side structure on the driver side and rearwardmost seating of the vehicle, a second portion inflatable between the side structure on the passenger side and the rearwardmost seating of the vehicle, and a third portion inflatable adjacent the rearwardmost seating and extending from said first portion to said second portion.

20. The apparatus recited in claim 19, wherein said inflatable vehicle occupant protection device comprises a single inflatable device including said first, second, and third portions.

21. The apparatus recited in claim 19, wherein said third portion of said inflatable vehicle occupant protection device is inflatable rearward of any occupant of the rearwardmost seating.

22. The apparatus recited in claim 19, wherein said third portion is inflatable between any vehicle occupant and a rear structure of the vehicle.

23. The apparatus recited in claim 22, wherein the rear structure includes a rear window opening, said third portion of said inflatable vehicle occupant protection device when inflated covering at least a portion of said rear window opening.

24. The apparatus recited in claim 19, wherein said second portion when inflated extends inboard from the side structure adjacent a seat back of the rearwardmost seating.

25. The apparatus recited in claim 19, wherein said first portion, said second portion, and said third portion of said inflatable vehicle occupant protection device comprise a single inflatable volume of said inflatable vehicle occupant protection device.

26. The apparatus recited in claim 19, wherein said first portion, said second portion, and said third portion of said inflatable vehicle occupant protection device comprise separate inflatable volumes of said inflatable vehicle occupant protection device.

27. The apparatus recited in claim 19, further comprising a fourth portion that when inflated extends inboard from said first portion and inboard from said second portion between forwardmost seating of the vehicle and a windshield opening of the vehicle.

28. The apparatus recited in claim 19, wherein said first portion when inflated extends along the side structure on the driver side from adjacent forwardmost seating of the vehicle to adjacent the rearwardmost vehicle seating, and said second portion when inflated extends along the side structure on the passenger side from adjacent the forwardmost vehicle seating to adjacent the rearwardmost vehicle seating.

29. The apparatus recited in claim 19, wherein said first portion when inflated extends from near a forwardmost pillar of the side structure on the driver side of the vehicle to near a rearwardmost pillar of the side structure on the driver side of the vehicle, and said second portion when inflated extends from near a forwardmost pillar of the side structure on the passenger side of the vehicle to near a rearwardmost pillar of the side structure on the passenger side of the vehicle.

30. The apparatus recited in claim 19, wherein said second portion when inflated extends from near a rearwardmost pillar of the side structure on the driver side of the vehicle to near a rearwardmost pillar of the side structure on the passenger side of the vehicle.

31. The apparatus recited in claim 19, wherein said first portion extends along a perimeter of the vehicle roof from near the forwardmost pillar on the driver side to near the rearwardmost pillar on the driver side, said second portion extends along the perimeter of the vehicle roof from near the forwardmost pillar on the passenger side to near the rearwardmost pillar on the passenger side, and said third portion extends along the perimeter of the vehicle roof from near the rearwardmost pillar on the driver side to near the rearwardmost pillar on the passenger side.

32. An apparatus for helping to protect an occupant of a vehicle that has a side structure and a roof, said apparatus comprising an inflatable vehicle occupant protection device that is inflatable away from the vehicle roof, said inflatable vehicle occupant protection device comprising a first portion that when inflated extends between the vehicle side structure and forwardmost and rearwardmost seating of the vehicle and a second portion that when inflated extends inboard from the first portion adjacent the rearwardmost seating.

33. An apparatus for helping to protect an occupant of a vehicle, said apparatus comprising an inflatable curtain that has a first portion when inflated extending along a side structure of the vehicle on a driver side of the vehicle, a second portion when inflated extending along a side structure of the vehicle on a passenger side of the vehicle, and a third portion when inflated extending along a rear structure of the vehicle from the first portion to the second portion.

34. The apparatus recited in claim 33, further comprising a fourth portion that when inflated extends from the first portion to the second portion and covers a windshield opening of the vehicle.

35. An apparatus for helping to protect an occupant of a vehicle, said apparatus comprising an inflatable curtain that extends along a perimeter of a roof of the vehicle from near a forwardmost pillar of the vehicle to near a rearwardmost pillar of the vehicle and along the perimeter of the roof from near the rearwardmost pillar of the vehicle to near a longitudinal centerline of the vehicle.

36. An apparatus for helping to protect occupants of a vehicle, said apparatus comprising an inflatable vehicle occupant protection device that when inflated extends along the entire perimeter of a roof of the vehicle and downward into an occupant compartment of the vehicle so as to surround the occupant compartment to protect all occupants of the vehicle.

37. An apparatus for helping to protect occupants of a vehicle having an occupant compartment, said apparatus comprising an inflatable vehicle occupant protection device that when inflated surrounds the occupant compartment to protect all occupants in the occupant compartment.

38. An apparatus for helping to protect an occupant of a vehicle that has a side structure and a roof, said apparatus comprising an inflatable vehicle occupant protection device that is inflatable away from the vehicle roof, said inflatable vehicle occupant protection device comprising a first portion that when inflated extends between the vehicle side structure and a seating position of the vehicle and a second portion that when inflated extends inboard from the first portion adjacent the seating position, said second portion terminating adjacent or just beyond a vehicle centerline.

39. An apparatus for helping to protect an occupant of a vehicle that has a driver side including a side structure, a passenger side including a side structure, and a roof, said apparatus comprising:
a driver side inflatable vehicle occupant protection device that is inflatable away from the vehicle roof, said driver side inflatable vehicle occupant protection device comprising a first portion that when inflated extends between the driver side structure and a driver side seating position and a second portion that when inflated extends inboard from the first portion adjacent the driver side seating position; and
a passenger side inflatable vehicle occupant protection device that is inflatable away from the vehicle roof, said passenger side inflatable vehicle occupant protection device comprising a third portion that when inflated extends between the passenger side structure and a passenger side seating position and a fourth portion that when inflated extends inboard from the third portion adjacent the passenger side seating position, said second portion and said fourth portion having respective terminal end portions that abut each other adjacent a centerline of the vehicle.

40. The apparatus recited in claim 39, wherein said second portion and said fourth portion overlap each other.

41. An apparatus for helping to protect an occupant of a vehicle, said apparatus comprising an inflatable vehicle occupant protection device inflatable in response to a rear impact with the vehicle, said inflatable vehicle occupant protection device when inflated extending across a rear window opening of the vehicle.
